(19) United States
(12) Patent Application Publication
(10) Pub. No.: US 2008/0229821 A1
(43) Pub. Date: Sep. 25, 2008

(54) SENSOR IMPACT PROTECTION APPARATUS

(76) Inventors: KEVIN R. REEDER, CARSON CITY, MI (US); DERRICK W. ANDERSON, JACKSON, MI (US); MICHAEL STEBLI, TOLEDO, OH (US); MARKUS SCHUSTER, ANN ARBOR, MI (US)

Correspondence Address: HARNESS, DICKEY & PIERCE, P.L.C., P.O. BOX 828, BLOOMFIELD HILLS, MI, 48303, US

(21) Appl. No.: 11/688,292

(22) Filed: Mar. 20, 2007

(51) Int. Cl. G01D 11/24

(52) U.S. Cl. 73/431

(57) ABSTRACT

An impact protection element for a sensor housed in a boss features a hollow base element adapted to overlie the boss and a pair of legs extending along opposite sides of the boss.

### BACKGROUND

### Field

The disclosed teachings relate generally to impact protection for sensor elements. More specifically, the teachings are directed to impact protectors for sensors used in vehicular exhaust systems.

Sensors used in, for example, automotive applications are built to withstand temperature and vibration extremes in use. However, such sensors may be prone to damage by impact with obstacles during manufacturing of the device with which they are associated, during assembly of the system, such as an automobile, in which the sensor is associated, or during use of the system.

Hence, there is seen to be a need in the art for an impact preventing device for such sensors.

### SUMMARY

Accordingly, a protection element for a sensor associated with an exhaust system of a vehicle includes a hollow base portion adapted for at least partially surrounding a longitudinal axis of an associated sensor, and first and second legs extending from the base portion and adapted for coupling to a device of the exhaust system.

In another aspect of the disclosed teachings, an automotive exhaust treatment device includes a sensor mounting boss housing a sensor and extending from a surface of the exhaust treatment device. A sensor protector having a base portion positioned above the mounting boss additionally includes first and second legs extending from the base portion and fixedly coupled to the surface on opposite sides of the boss.

### BRIEF DESCRIPTION OF THE DRAWING

The objects and features of the invention will become apparent from a reading of a detailed description, taken in conjunction with the drawing, in which:

FIG. 1a is a perspective view of a piece of tubing showing cutting lines for producing two sensor protectors arranged in accordance with the principles of the disclosed teachings;

FIG. 1b is a perspective view of two sensor protectors fashioned by cutting the tubing along the cutting lines shown in FIG. 1a;

FIG. 2 is a side view of the tubing of FIG. 1a prior to cutting it into two sensor protectors in accordance with the principles of the disclosed teachings;

FIG. 3 is a side view of the tubing of FIG. 1a taken from a side opposite to that of FIG. 2;

FIG. 4 is a perspective view of an alternative embodiment of a sensor protector arranged in accordance with the principles of the disclosed teachings;

FIG. 5 is a perspective view of the sensor protector of FIG. 4 shown mounted for protection of a sensor associated with an exhaust treatment device in accordance with the principles of the disclosed teachings; and

FIG. 6 is a perspective view of a second alternative embodiment of a sensor protection element arranged in accordance with the principles of the disclosed teachings; and

FIG. 7 is a perspective view of the sensor protection element of FIG. 6 mounted for protection of a sensor associated with an exhaust treatment device in accordance with the principles of the disclosed teachings.

### DETAILED DESCRIPTION

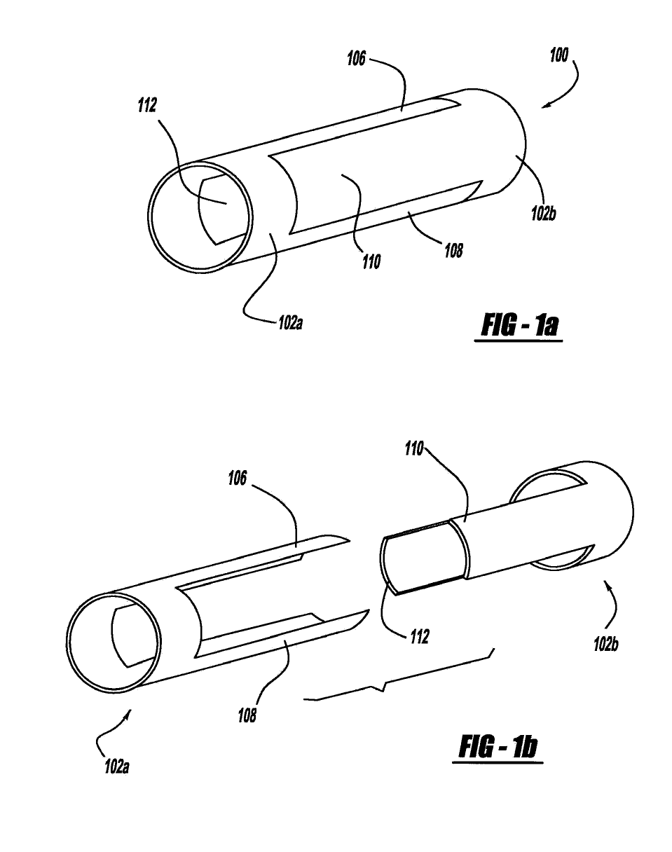

With reference to FIGS. 1a, 1b, 2 and 3, two sensor protector elements are fashioned from tubing 100 by cutting the tubing along the lines shown in FIGS. 1a, 2 and 3.

After the tubing is cut, the two elements shown in the exploded view of FIG. 1b result in two protectors 102a and 102b. A first sensor protector 102a has a substantially cylindrical base portion from which first and second legs 106 and 108 extend. Similarly, sensor protection element 102b has a substantially cylindrical base portion with two legs 110 and 112 extending therefrom. FIGS. 2 and 3 show side views of the tube of FIG. 1a prior to cutting and separation. With this fabrication approach, the mounting legs are integral with their base portions.

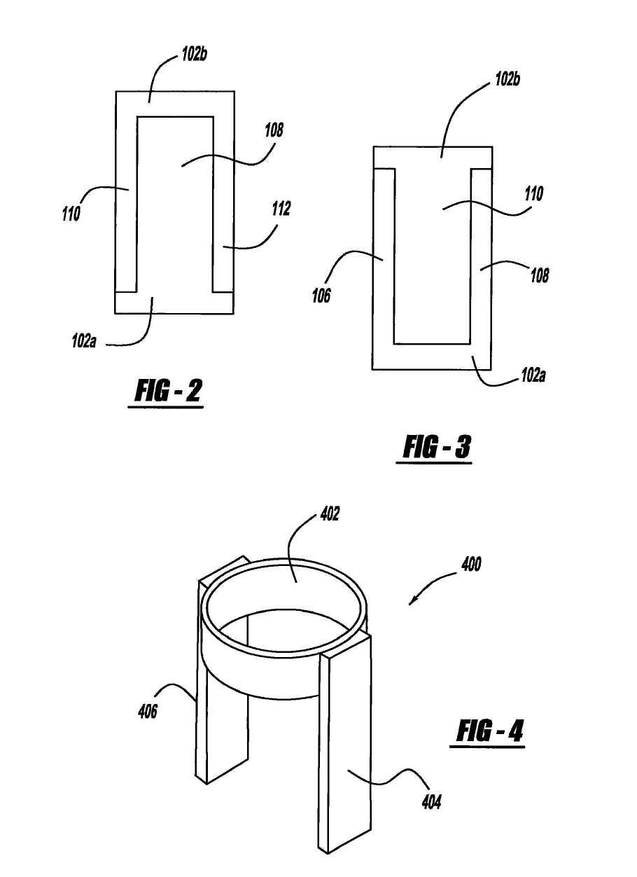

An alternative protection element is shown in FIG. 4. Sensor protection element 400 has a substantially cylindrical hollow base portion 402 from which two legs 404 and 406 extend. Legs 404 and 406 can, for example, be fixedly coupled to base portion 402 by welding or other suitable attachment processes.

In automotive applications, the protection elements of FIGS. 1-3 or FIG. 4, and the sensor which they are designed to protect are, for example, configured in association with an exhaust after-treatment device as shown in FIG. 5.

Exhaust after-treatment device 500 may comprise a variety of exhaust system elements, including, without limitation, mufflers, catalytic converters, particulate filters, or simply an exhaust conduit such as an exhaust pipe or manifold.

In the example shown in FIG. 5, after-treatment device 500 has an inlet conduit 504 at one end of its housing 502. Extending outwardly from inlet tube 504 is a sensor and sensor mounting boss 506. As seen from FIG. 5, sensor protection element 400 (as shown in FIG. 4) is placed such that its base portion 402 overlies mounting boss 506 while legs 404 and 406 extend from base portion 402 on opposite sides of mounting boss 506 and are fixedly coupled to the device at its inlet 504 by suitable attachment means, such as welding. Base portion 402 may be open at its end allowing for the passage of a sensor cable 508 which, in most applications would extend to a unit utilizing the sensor signals, such as an engine control unit of a motor vehicle.

Surrounding cable 508 as it exits boss 506 is a hardened cable shield 510 fashioned, for example, from a metallic substance. Shield 510 extends from boss 506 through and beyond the boss portion 402 of sensor protection element 400. In this way, during assembly or in use, cable 508 will not be damaged by coming into contact with protection element 400.

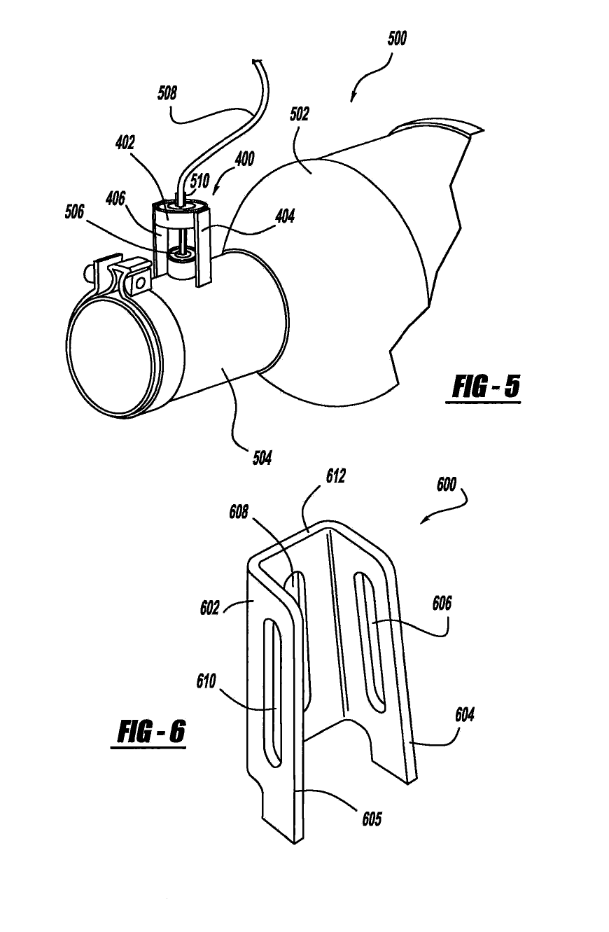

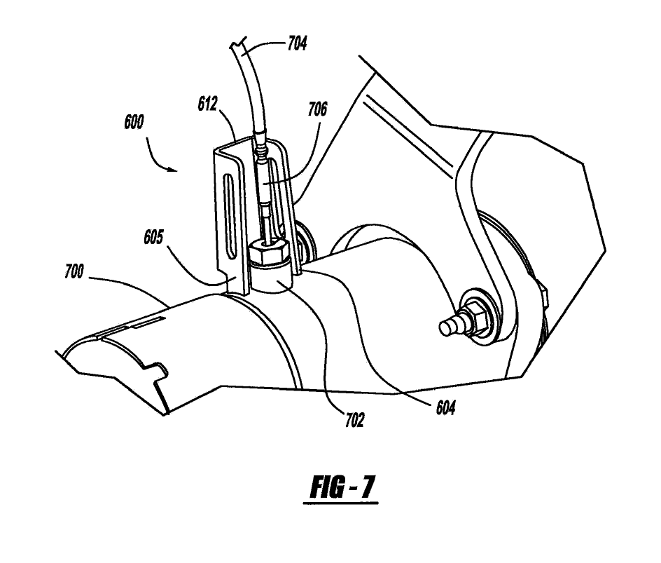

A second alternative embodiment of a sensor protection element 600 is set forth in FIG. 6. Protection element 600 has first and second mounting legs 604 and 605 and a 3-walled base portion 602 adapted to extend along three sides of a longitudinal axis of a sensor being protected. Each wall of the base portion 602 has an associated aperture 606, 608 and 610. Base portion 602 terminates at its end opposite mounting legs 604 and 605 at edge surface 612.

FIG. 7 sets forth an example application of sensor protection element 600 in an automotive exhaust system environment. As with the application example of FIG. 5, exhaust after-treatment device 700 may comprise a variety of exhaust system components, including, without limitation, mufflers, catalytic converters, particulate filters, or simply an exhaust conduit such as an exhaust pipe or manifold.

As seen from FIG. 7, a sensor and sensor mounting boss 702 extends from after-treatment device 700. Mounted to device 700 on opposite sides of boss 702 are legs 604 and 605 of protection element 600. Base portion 602 extends along three sides around a longitudinal axis of sensor and sensor boss 702 so as to surround sensor cable 704 and its cable shield 706. The open face of base portion 602 faces the vehicle undercarriage or any exhaust system or vehicle component providing a natural impact shield at that side of the sensor boss.

Sensor protection elements arranged as shown in the teachings herein are suitable for use with a wide variety of sensors, including, without limitation, oxygen sensors, temperature sensors, pressure sensors, nitrous oxide sensors, ammonia sensors, etc.

The detailed description has been set forth for the sake of example only and is not to be construed as a limitation on the invention. The invention will be found in the appropriately interpreted appended claims.

What is claimed is:

1. A protection element for a sensor associated with an exhaust system of a vehicle, the protection element comprising:
a hollow base portion adapted for at least partially surrounding a longitudinal axis of an associated sensor; and
first and second legs extending from the base portion and adapted for coupling to a device of the exhaust system.

2. The protection element of claim 1 wherein the hollow base portion has an opening for receipt of a sensor cable extending from the sensor.

3. The protection element of claim 1 wherein the first and second legs are adapted for coupling to the device by welding.

4. The protection element of claim 1 wherein the first and second legs are formed integrally with the base portion.

5. The protection element of claim 1 wherein the first and second legs are formed separately from the base portion and fixedly coupled thereto.

6. The protection element of claim 1 wherein the base portion is adapted to be positioned above a boss holding the sensor and extending from the device, and the first and second legs are adapted for coupling to the device on opposite sides of the boss.

7. An automotive exhaust treatment device comprising:
a sensor mounting boss housing a sensor and extending from a surface of the exhaust treatment device; and
a sensor protector having a base portion positioned above the mounting boss and first and second legs extending from the base portion and fixedly coupled to the surface on opposite sides of the boss.

8. The automatic exhaust treatment device of claim 7 further comprising:
a sensor signal conducting lead extending from the sensor through the base portion of the sensor protector; and
a shield surrounding the lead from the mounting boss at least completely through the base portion of the sensor protector.

9. The automotive exhaust treatment device of claim 7 wherein the device comprises a muffler.

10. The automotive exhaust treatment device of claim 7 wherein the device comprises a catalytic converter.

11. The automotive exhaust treatment device of claim 7 wherein the device comprises a particulate filter.

12. The automotive exhaust treatment device of claim 7 wherein the device comprises an exhaust conduit.
